(19) United States
(12) Patent Application Publication
(10) Pub. No.: US 2006/0136520 A1
(43) Pub. Date: Jun. 22, 2006

(54) Apparatus, method and computer program to provide metadata-based data transfer from one mobile terminal to another mobile terminal

(75) Inventors: Mika Leppinen, Espoo (FI); Antti Keinanen, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/016,190

(22) Filed: Dec. 17, 2004

(51) Int. Cl. G06F 17/30

(52) U.S. Cl. 707/204

(57) ABSTRACT

A method is disclosed to transfer data from a first terminal to a second terminal. The method includes establishing metadata to specify particulars of the data to be transferred; and selectively transferring data via a link from a memory of the first terminal to a memory of the second terminal in accordance with the metadata. A terminal includes a memory that stores data, a user interface and a controller that is coupled to the memory to selectively transfer data for storage in a memory of another terminal via an interface. The controller includes or implements a data filter coupled to metadata storage, where the metadata may be at least partially established by a user via the user interface to specify particulars of the data to be transferred.

### TECHNICAL FIELD

The presently preferred embodiments of this invention relate generally to portable communications devices and terminals, referred to for convenience as mobile stations or mobile terminals, and more specifically relate to techniques to transfer user and other data from one mobile terminal to another mobile terminal.

### BACKGROUND

The amount of user data stored within modern mobile terminals has increased as the memory capabilities of mobile terminals have been enhanced. This user data can include, in addition to the conventional telephone directory containing at least names and telephone numbers, image data that is captured with a built-in digital camera, downloaded ring tones, music and game files, as well as email messages, web pages and other Internet-related information that is downloaded via a wireless Internet connected browser.

A problem that can arise in this context concerns a user who replaces a mobile terminal (the “old” mobile terminal) with another mobile terminal (the “new” mobile terminal). Due to the significant increase in the amount of stored data, it may not be desirable to simply transfer all stored data from the old mobile terminal to the new mobile terminal. If the user simply blindly copies always all data from the old mobile terminal to the new, the new mobile terminal's memory may contain a large amount of data that is no longer needed, that is out of date, and that unnecessarily consumes memory space that would be better used to stored other data.

Prior to this invention, this problem was not adequately addressed and was not resolved.

### SUMMARY OF THE PREFERRED EMBODIMENTS

The foregoing and other problems are overcome, and other advantages are realized, in accordance with the presently preferred embodiments of this invention.

In accordance with one aspect of this invention a method is disclosed to transfer data from a first terminal to a second terminal. The method includes establishing metadata to specify particulars of the data to be transferred; and selectively transferring data via a link from a memory of the first terminal to a memory of the second terminal in accordance with the metadata.

In accordance with another aspect of this invention an information storage medium stores a program of machine-readable instructions that are executable by a digital data processor to perform operations to transfer data from a first terminal to a second terminal. The operations comprise establishing metadata to specify particulars of the data to be transferred; and selectively transferring data via a link from a memory of the first terminal to a memory of the second terminal in accordance with the metadata.

In accordance with another aspect of this invention a terminal includes a memory that stores data, a user interface and a controller that is coupled to the memory to selectively transfer data for storage in a memory of another terminal via an interface. The controller comprises a data filter coupled to metadata storage, where the metadata may be at least partially established by a user via the user interface to specify particulars of the data to be transferred.

In accordance with a further aspect of this invention a mobile terminal includes memory means that stores data in a file system; user interface means; and control means coupled to the memory means to selectively transfer some of the data for storage in a file system of another terminal via an interface means. The control means comprises data filter means coupled to metadata storage means, where the metadata is at least partially established by a user via the user interface means to specify particulars of the data to be transferred.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 is a logic flow diagram that illustrates a telephone book embodiment of this invention;

FIG. 2 is a block diagram that shows two mobile terminals arranged to transfer data from one to the other in accordance with embodiments of this invention; and

FIG. 3 shows a transfer mode data filter and metadata that is coupled between the file system of the old terminal and the file system of the new terminal in accordance with embodiments of this invention.

### DETAILED DESCRIPTION OF THE PREFERRED EMBODIMENTS

The embodiments of this invention relate to transferring user data between mobile terminals. One non-limiting embodiment provides a mechanism to transfer content from an old mobile terminal to a new mobile terminal in a product replacement situation. By applying metadata during the data transfer more value can be created to the end user, as only relevant content is transferred and/or data is converted so as to be optimized for the new mobile terminal.

An aspect of this invention resides in the use of metadata that is applied during the data transfer process. As an example, stored data that has not been accessed for some specified period of time (e.g., never, or not within the past three months) is not transferred, or it is transferred to a separate folder. Preferably the user can select a profile to be applied during the transfer, and may thus specify the metadata to be used. If the data is transferred to a mobile terminal that supports a different data format, then the data is automatically reformatted to be compatible with the data format of the new mobile terminal.

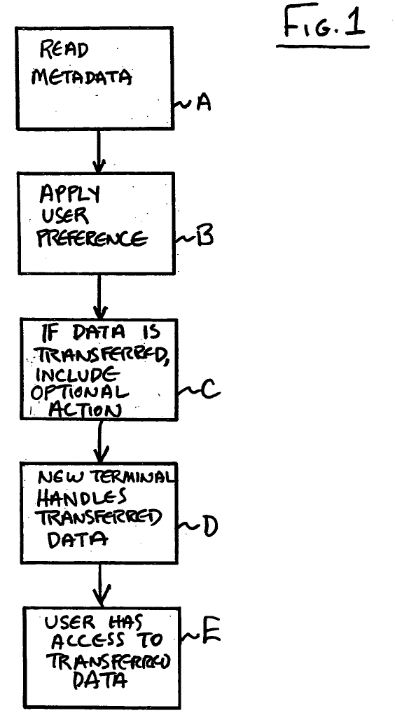

The specifics of the implementation logic is function of the nature of the data that is transferred. For example, in the case of data that represents phone book entries, and referring to the logic flow diagram of FIG. 1:

Block A. the metadata is read, and a determination may be made as to (as non-limiting examples):
how frequently the data have been used;
have the data been transferred previously earlier;
have the data been synchronized to other devices or to a server;

Block B. the user preference is applied (e.g., transfer or not, put in special folder);

Block C. if the data is transferred then include an additional (optional) action (e.g. put into old folder);

Block D. the new mobile terminal handles the transferred data according to the specified action;

Block E. at the end of the process, the user can see that phone book contains only “fresh” elements, such as only those telephone numbers that were called within, for example, the last three months (or from which a call was received in the last three months), and all other numbers may simply be deleted, or they may be placed in a special folder containing “stale” contact information.

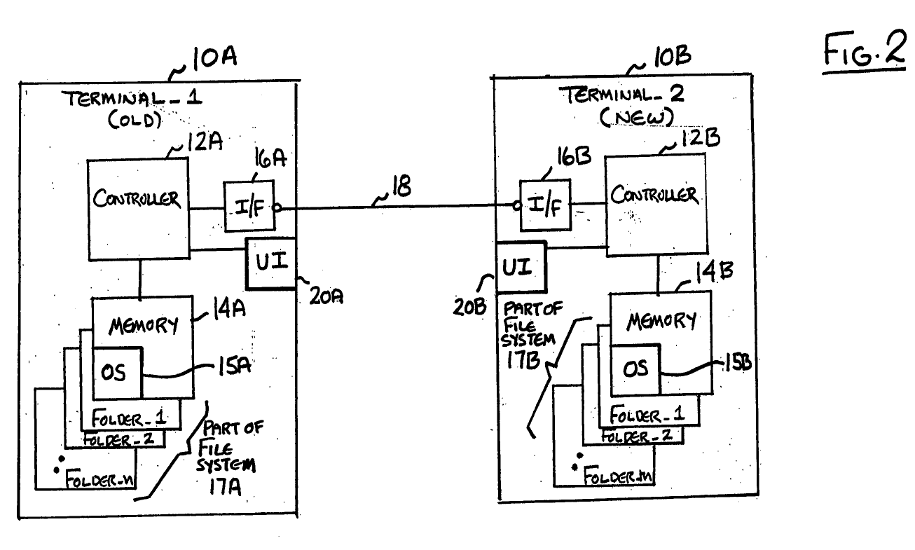

Reference is now made to FIG. 2 for showing a block diagram of two mobile terminals arranged to transfer data from one to the other in accordance with embodiments of this invention. The mobile terminals are referred to as a Terminal_1, or the “old” mobile terminal 10A, and as a Terminal_2, or the “new” mobile terminal 10B. Mobile terminals 10A and 10B may the same type of terminal, where mobile terminal 10B is simply a replacement for mobile terminal 10A, or mobile terminal 10B may be a different type of mobile terminal that is manufactured by the same or a different manufacturer as the mobile terminal 10A.

In general, the various embodiments of the mobile terminals 10A and 10B can include, but are not limited to, cellular telephones, personal digital assistants (PDAs), computers including portable computers such as laptops, image capture devices such as digital cameras, gaming devices, music storage and playback appliances, Internet appliances permitting wireless and/or wired Internet access and browsing, as well as portable units or terminals that incorporate combinations of such functions. The two terminals 10A and 10B are not required to be the same type of device. As one non-limiting example, terminal 10A may be a PDA, terminal 10B may be a cellular telephone, and the transferred data may be a telephone/address book that is stored in the PDA.

For the purposes of this description each of the terminals 10A, 10B is assumed to include a digital data processor, also referred to as a controller 12A, 12B, respectively, that may be embodied as a microprocessor that operates under control of a program stored in a memory 14A, 14B, respectively. The memories 14A and 14B may each store an operating system (OS) 15A, 15B, respectively, such as one known as Symbian®. The OS 15A, 15B may manage data and the memory such that there a plurality of logical folders established, such as Folder_1 through Folder_n in memory 14A and Folder_1 through Folder_m in memory 14B, where n may or may not be equal to m. As one example, one folder may store telephone book contact information, another may store image data, and another may store downloaded content, such as music files. Folders may be created or deleted by the OS 15, and a given folder may contain one or more sub-folders. During the transfer of data it is assumed that, unless specified differently by the user, data from some folder_i in terminal 10A is transferred to a similar type of folder in the terminal 10B. For example, images taken by the user of terminal 10A and stored in folder c:\nokia\images in terminal 10A are transferred to a folder c:\nokia\images in terminal 10B. The various folders may be considered to form a part of a file system 17A, 17B associated with each OS 15A, 15B.

The terminals 10A, 10B are coupled together via interfaces (I/F) 16A, 16B and a link 18 at least for the purpose of transferring data from terminal 10A to terminal 10B in accordance with the embodiments of this invention. The link 18 may be an infrared (IR) link, or a radio frequency (RF) link, such as a Bluetooth™ link, or it may be a wired link. Whatever the particular link-type, the I/Fs 16A, 16B are assumed to be compatible, and to provide the physical and higher layer support, protocols and protocol stacks.

Each terminal 10A, 10B may include a user interface (UI) 20A, 20B, respectively, such as a keypad/keyboard or a touch screen interface and a display. The UIs 20A, 20B may take the form of a graphical user interface (GUI).

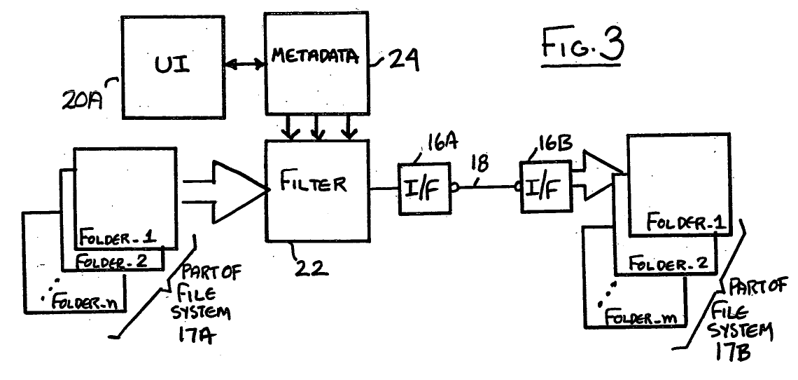

FIG. 3 shows a transfer mode data filter 22 and metadata 24 that is coupled between the file system 17A of the old terminal 10A and the file system 17B of the new terminal 10B in accordance with embodiments of this invention. More specifically, FIG. 3 shows a logical representation of the operation of the controllers 12A, 12B during the execution of a program in accordance with this invention. Operating under control of the stored program the controller 12A may be considered to implement the filter 22 that is controlled by the metadata 24. The metadata 24 may be fixed, but preferably it is changeable by the user via the UI 20A. Through the use of the UI 20A the user may be able to specify the particulars of the data transfer, such as by the use of the following exemplary and non-limiting menu selections presented by a Transfer Mode application:

Transfer Mode

Telephone Book

All entries
Only entries accessed within the last (days, weeks,
months)
Other criteria

Transfer non-selected entries and save in non-selected
folder

Images

All image files
Only image files created since (date)
Only image files viewed within the last (days, weeks,
months)
Other criteria

Transfer non-selected images and save in non-selected
folder

Music

All music files
Only music files played with last (days, weeks, months)
Other criteria

Transfer non-selected music files and save in
non-selected folder

.
.
.

These various UI-generated (or possibly defaulted) menu selections thus form the basis of the metadata 24 that is used to control the operation of the filter 22. In conventional usage “meta” is a prefix that in most information technology usages means “an underlying definition or description.” Thus, “metadata” is a definition or description of data. For the purposes of this invention the metadata 24 may be considered to form a set of criteria or instructions for directing the operation of the filter 22. Note that the filter 22 may actually be comprised of multiple filters, such as one optimized for telephone book entries, one optimized for image content, and one optimized for music content, where each filter operates under control of its own metadata.

It should be noted that the filter 22 and metadata 24 may be, located at the receiving terminal (the new terminal 10B), whereby all data is transferred from the old terminal 10A through the link 18, and is then selectively retained and stored or deleted at the new terminal 10B. In this case the metadata 24 may be generated at the old terminal 10A and transferred through the link 18 to the new terminal 10B, or it may be generated at the new terminal 10B.

It should further be appreciated that a function of the filter 22, whether located at the old terminal 10A, at the new terminal 10B, or distributed between the old terminal 10A and the new terminal 10B, may be to ensure that the data is correctly formatted before it is stored in the memory 14B, such as the file system 17B, of the new terminal 10B.

Note that if a particular item of data is not transferred from the old terminal 10A to the new terminal 10B, then that item of data can be considered to be effectively deleted, relative to the new terminal 10B, even though it may still exist at the old terminal 10A. Note further in this regard that the old terminal 10A may still be used, and is not necessarily taken out of service in favor of the new terminal 10B.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims.

For example, in addition to the various types of transferred data referred to above, the embodiments of this invention may be used to transfer calendar entries, sounds, video clips, notes, messages, email, settings, documents, files, installed applications, games and game high scores as but a few additional non-limiting examples of transferable data. In any of these cases the exemplary Transfer Mode user menu depicted above may be modified accordingly to give the user control over the specifics of the transfer of each of these various types of data.

Further by example, in other embodiments the link 18 may include cellular RF links and a network operator's infrastructure and/or the Internet and/or a local area network (LAN), either a wired LAN or a wireless LAN (WLAN). As was noted above, the link 18 may be an IR or an RF link, such as a Bluetooth™ link. The link 18 could also be implemented in whole or in part using a physical data transfer medium such as a non-volatile removable semiconductor memory module or a removable disk or tape-based storage module.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to transfer data from a first terminal to a second terminal, comprising:
establishing metadata to specify particulars of the data to be transferred; and
selectively transferring data via a link from a memory of the first terminal to a memory of the second terminal in accordance with the metadata.

2. A method as in claim 1, where the metadata comprises a specification of a type of data.

3. A method as in claim 1, where the metadata comprises a specification of at least one of a date or time associated with data.

4. A method as in claim 1, where the metadata comprises a specification of a prior usage of data.

5. A method as in claim 1, where a result of selectively transferring is that not all data stored in the first memory is stored in the second memory.

6. A method as in claim 1, where the link is comprised of a wireless link.

7. A method as in claim 1, where the link is comprised of a wired link.

8. An information storage medium storing a program of machine-readable instructions executable by a digital data processor to perform operations to transfer data from a first terminal to a second terminal, the operations comprising:
establishing metadata to specify particulars of the data to be transferred; and
selectively transferring data via a link from a memory of the first terminal to a memory of the second terminal in accordance with the metadata.

9. An information storage medium as in claim 8, where the metadata comprises a specification of a type of data.

10. An information storage medium as in claim 8, where the metadata comprises a specification of at least one of a date or time associated with data.

11. An information storage medium as in claim 8, where the metadata comprises a specification of a prior usage of data.

12. An information storage medium as in claim 8, where a result of execution of the operation of selectively transferring is that not all data stored in the first memory is stored in the second memory.

13. An information storage medium as in claim 8, where the link is comprised of a wireless link.

14. An information storage medium as in claim 8, where the link is comprised of a wired link.

15. A terminal, comprising:
a memory that stores data;
a user interface; and
a controller coupled to the memory to selectively transfer data for storage in a memory of another terminal via an interface, said controller comprising a data filter coupled to metadata storage, where said metadata is at least partially established by a user via said user interface to specify particulars of the data to be transferred.

16. A terminal as in claim 15, where the metadata comprises a specification of a type of data.

17. A terminal as in claim 15, where the metadata comprises a specification of at least one of a date or time associated with data.

18. A terminal as in claim 15, where the metadata comprises a specification of a prior usage of data.

19. A terminal as in claim 15, where a result of selectively transferring is that not all data stored in the memory of the mobile terminal is stored in the memory of the another terminal.

20. A terminal as in claim 15, where the interface is coupled to a wireless link.

21. A terminal as in claim 15, where the interface is coupled to a wired link.

22. A terminal as in claim 15, where the data comprises at least one of telephone directory data, image data, and previously downloaded content.

23. A terminal as in claim 15, where the terminal is comprised of a cellular telephone, and where the data is comprised of telephone directory data.

24. A mobile terminal, comprising:
memory means that stores data in a file system;
user interface means; and
control means coupled to the memory means to selectively transfer some of the data for storage in a file system of another terminal via an interface means, said control means comprising data filter means coupled to metadata storage means, where said metadata is at least partially established by a user via said user interface means to specify particulars of the data to be transferred.

25. A mobile terminal as in claim 24, where the metadata comprises a specification of at least one of a type of data, at least one of a date or time associated with data, and prior usage of data.

26. A mobile terminal as in claim 24, where the interface means is coupled to a wireless link means.

27. A mobile terminal as in claim 24, where the interface means is coupled to a wired link means.

28. A mobile terminal as in claim 24, where the data comprises at least one of telephone directory data, image data, and previously downloaded content.

29. A mobile terminal as in claim 24, where the mobile terminal is comprised of a cellular telephone, and where the data is comprised of telephone directory data.
